(19) United States
(12) Patent Application Publication
(10) Pub. No.: US 2026/0316858 A1
(43) Pub. Date: Oct. 15, 2026

(54) TAPERED TRACK LINK, TRACK LINK ASSEMBLY, AND TRACK ASSEMBLY

(71) Applicant: Caterpillar Inc., Peoria, IL (US)

(72) Inventors: Martin Tagore Joseph XAVIER, Tamil nadu (IN); Anvesh TIWARI, CHENNAI (TAMIL NADU) (IN)

(73) Assignee: Caterpillar Inc., Peoria, IL (US)

(21) Appl. No.: 19/178,292

(22) Filed: Apr. 14, 2025

(51) Int. Cl. B62D 55/20; B62D 55/21

(52) U.S. Cl. CPC B62D 55/202; B62D 55/213

(57) ABSTRACT

A track link for a track link assembly includes a first end, a second end opposite to the first end, an interior end extending between the first end and the second end, and an exterior end extending between the first end and the second end, the exterior end being opposite to the interior end. The track link also includes a top end having a tapered surface, the top end connecting the interior end and the exterior end, the interior end having a greater height as compared to a height of the exterior end due to the tapered surface.

### TECHNICAL FIELD

The present disclosure relates generally to a track link assembly, and, more particularly, to a tapered track link for a track link assembly.

### BACKGROUND

Each track assembly of a track-type machine, such as a dozer, an excavator, or a skid-steer loader, includes a loop of interconnected track link assemblies and a series of track shoes, referred to as a track, that moves or rotates around a drive sprocket, an idler, and a roller assembly. The idler and roller assembly includes rollers, or cylindrical wheels, that support the weight of the machine, guide and support the track link assemblies, and are positioned within the loop of track link assemblies.

The rollers include a top carrier roller and bottom track rollers. The top carrier roller is located toward the top of the track assembly to support and guide the track link assemblies and prevent the track link assemblies from slipping off the track (also referred to as slippage), during operation of machines in side-slope applications. The bottom track rollers are located along the bottom of the track assembly to displace loads along the track. Roller assemblies typically include a combination of track rollers with differing structures in an alternating arrangement. Roller assemblies can also include one or more idler wheels located at the front or rear of the machine.

The individual links of track assemblies are connected in series and end to end. The track assembly can include straight link chains with alternating inner and outer links, or can include offset link chains where all the links are alike. Each track link assembly is pivotably connected to adjacent link assemblies in the loop. As the track assembly translates (e.g., via the driving of a sprocket), the connected track links engage the ground surface under the machine, for example, via track shoes that are coupled to the track chain, which propels the machine on the ground surface. Flanges placed on the carrier and track rollers can prevent track slippage but increase cost and can increase manufacturing complexity.

U.S. Pat. No. 10,710,653, issued on Jul. 14, 2020 (“the '653 patent”), describes a self-aligning idler wheel design for use with elastomeric tracks. The idler wheel design of the '653 patent has an outer diameter that is greater than an inside diameter of the wheel. This arrangement places tension on an elastomeric track when the track contacts the inside diameter of the idler wheel, the tension tending to reduce the likelihood of track misalignment. The shape of the idler wheels described in the '653 patent do not provide a track assembly having tapered track links.

The system and method of the present disclosure may solve one or more of the problems set forth above or other problems in the art. The scope of the current disclosure, however, is defined by the attached claims, and not by the ability to solve any specific problem.

### SUMMARY

In one aspect, a track link for a track link assembly may include a first end, a second end opposite to the first end, an interior end extending between the first end and the second end, and an exterior end extending between the first end and the second end, the exterior end being opposite to the interior end. The track link may also include a top end having a tapered surface, the top end connecting the interior end and the exterior end, the interior end having a greater height as compared to a height of the exterior end due to the tapered surface.

In another aspect, a track link assembly may include a first track link, the first track link having: a first end, a second end opposite to the first end, an interior end extending between the first end and the second end, an exterior end extending between the first end and the second end, the exterior end being opposite to the interior end, and a top end having a tapered surface, the top end connecting the interior end and the exterior end. The track link assembly may also include a second track link connected to and facing the first track link, the first track link having: a first end, a second end opposite to the first end, an interior end extending between the first end and the second end, an exterior end extending between the first end and the second end, the exterior end being opposite to the interior end, and a top end having a tapered surface, the top end of the first track link having a height that reduces in a direction from the interior end of the first track link to the exterior end of the first track link, and the top end of the second track link having a height that reduces in a direction from the interior end of the second track link to the exterior end of the second track link.

In yet another aspect, a track assembly for a machine, the track assembly including a track shoe, a first track link having: a through hole, a bottom surface connected to the track shoe, a top surface opposite to the bottom surface, the top surface being inclined with respect to a horizontal direction, a second track link, and a track pin connecting the first track link and the second track link, the track pin extending through the through hole and along a track pin axis that is parallel to the horizontal direction.

### BRIEF DESCRIPTION OF THE DRAWINGS

FIG. 1 is a perspective view of a dozer, as an example of a track-type machine, having track link assemblies, each including tapered track links, in accordance with the present disclosure.

FIG. 2 is a perspective view of a tapered track link, as part of a track link assembly shown in FIG. 1.

FIG. 3 is a front schematic view of the tapered track link assembly including a track link shown in FIG. 2 and a tapered roller.

FIG. 4 is a cross-sectional view of the tapered track link assembly including multiple track links according to the track link shown in FIG. 2.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

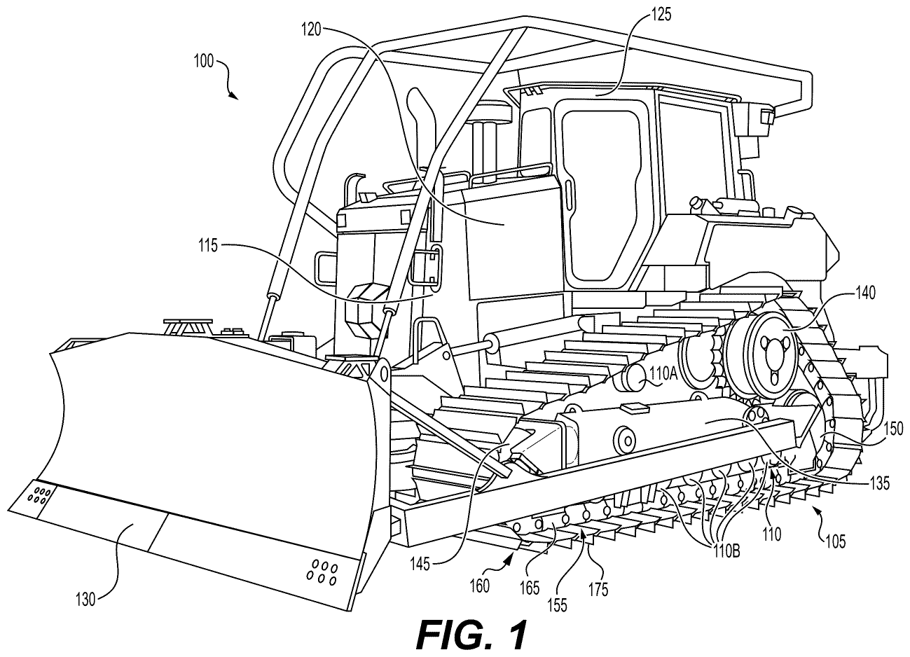

FIG. 1 shows a track-type machine 100 having two track assemblies 105 (only one shown), each track assembly 105 including a plurality of tapered track links 165, in accordance with the present disclosure. Machine 100 also includes a machine frame 115 supporting an engine 120 or other power-generating device (e.g., batteries, a fuel cell, a generator set, etc.), an operator station (or cab) 125, a work tool or implement in the form of a blade 130, and a track support frame 135 provided as part of an undercarriage of the machine frame 115.

Each track assembly 105 may include a drive sprocket 140, a front idler 145, a rear idler 150, track rollers 110, rollers 110 including at least one top carrier roller 110A and bottom track rollers 110B, and a plurality of track link assemblies 155 connected to a track 160. Track link assemblies 155, connected to each other in an end-to-end manner, may form a loop around sprocket 140, front idler 145, rear idler 150, and track rollers 110. Front idler 145 and rear idler 150 may aid in movement of track 160, and help to maintain alignment of track 160 and to maintain proper tension of track 160. Bottom track rollers 110B may support the weight of track 160 and help to maintain alignment of track 160. Bottom track rollers 110B, with carrier roller 110A, also help to minimize strain on sprocket 140 and on idlers 145 and 150.

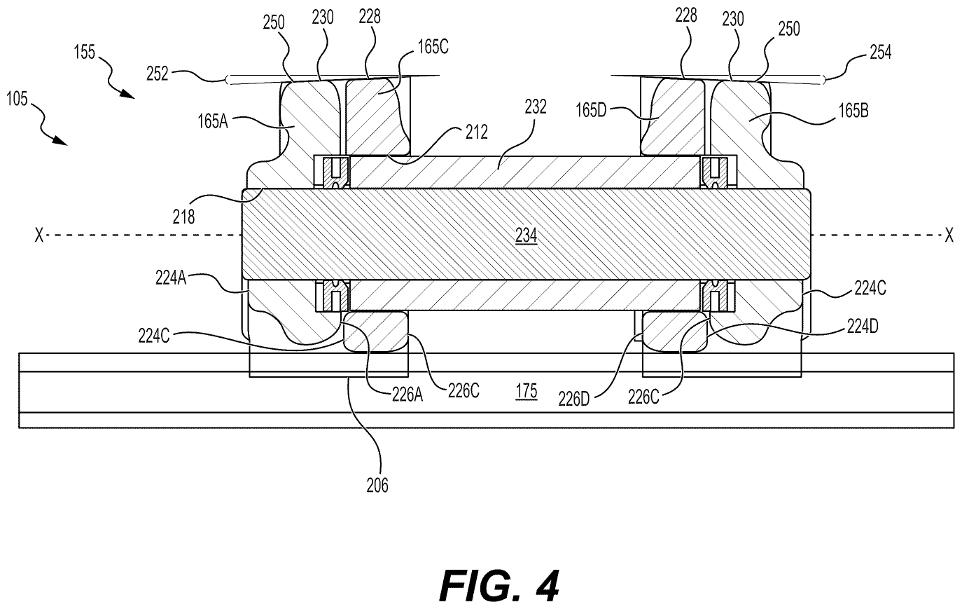

Each track link assembly 155 includes two laterally-opposed tapered track links 165, connected to each other using a bushing 232 (FIG. 4) and a link pin 234 (FIG. 4). Track link assemblies 155 may be connected in a series to form a loop, as described above, to which track shoes 175 are connected as part of the loop. Tapered track links 165 may be connected to track shoes 175 using bolts and nuts (not shown) or other suitable fasteners to form track assemblies 105. During operation, engine 120 is configured to generate power that is output through a final drive which transmits a force through a drive sprocket 140 to move track 160, including each track link assembly 155 and track shoe 175, around idlers 145 and 150 and rollers 110 to propel machine 100 forwards or backwards with engagement of track shoes 175 of a segment of the track 160 with ground material.

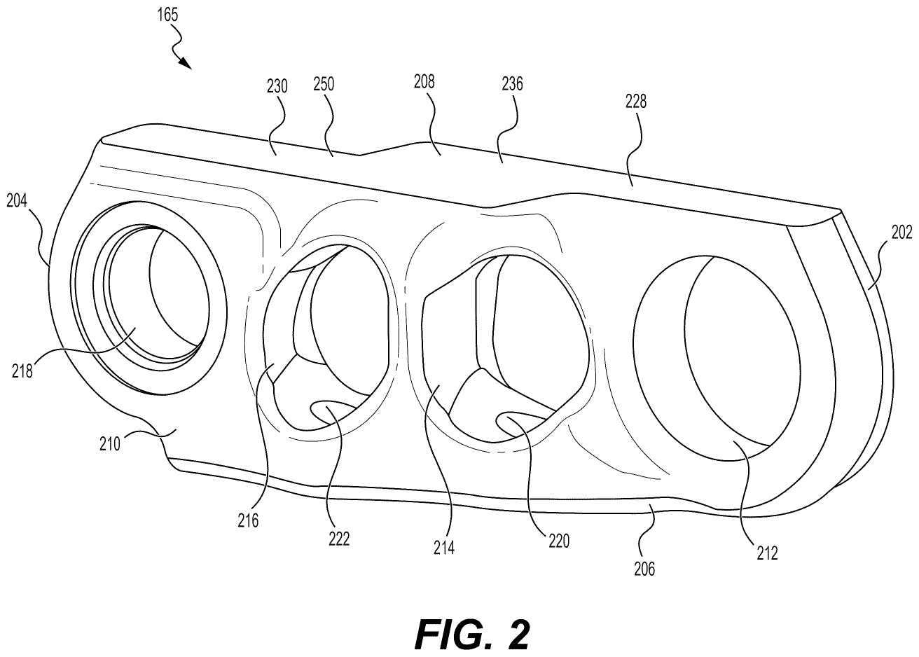

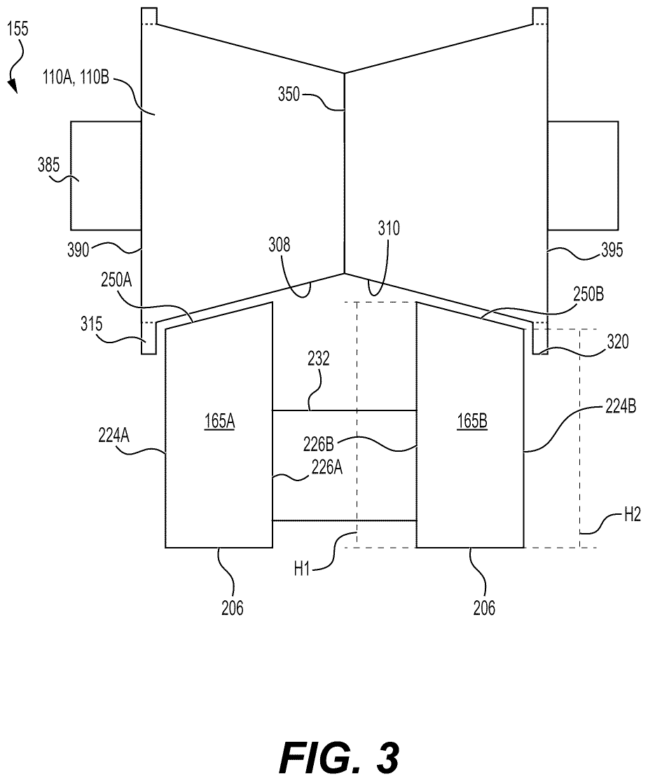

FIG. 2 is a perspective view of a tapered track link 165, which may form part of a track link assembly 155, in accordance with the present disclosure. As shown in FIG. 2, tapered track links 165 may include a body 210. Body 210 may be defined by a front end 202, a rear end 204, a bottom end 206, and a top end 208. Body 210 may also include an exterior end or outside end 224 (FIG. 3) and an interior end 226 (FIG. 3). Top end 208 may form a tapered top surface 250 that is inclined with respect to a horizontal direction, as described below. As used herein, “outer,” “outside,” and “outward” refer to directions that extend away from the midpoint between two laterally-connected track links 165 (e.g., a center of a bushing or pin connecting two links 165), while “inner,” “inside,” and “inward” refer to directions toward the midpoint between two laterally-connected track links 165.

Bottom end 206 may be formed opposite top end 208 and may have a shape that is complementary to a shape of a corresponding track shoe 175 (FIG. 4). In some aspects, bottom end 206 may be partially or entirely flat (see FIG. 3) so as to define a horizontally-extending plane. Body 210 may include a plurality of through holes or bores, with four holes shown in the configuration illustrated in FIG. 2. A bushing bore 212 may be closest to front end 202 and may be configured to align with pin bore 218 of a second track link 165. Window 214 and window 216 may facilitate assembly of tapered track links 165 to track shoes 175 (FIG. 4). In particular, window 214 may include a fastener hole 220 and window 216 may include a fastener hole 222. Fastener holes 220 and 222 may extend through bottom surface 206 and receive fasteners (e.g., bolts, nuts, spacers, etc.) for securing tapered track links 165 to track shoes 175.

Tapered top surface 250 may define a taper, or inclined surface. In some aspects, tapered top surface 250 is flat (e.g., planar) along its entirety, which extends from front end 202 to rear end 204 and from outside end 224 to interior end 226 (ends 224 and 226 shown in FIG. 3). Tapered top surface 250 may have a constant angle of inclination, resulting in a uniform taper along an entirety of surface 250. In particular, tapered top surface 250 may form a flat inclined surface that extends from an edge at outside end 224 to an edge at interior end 226.

Tapered top surface 250 may extend in a front-rear direction of tapered track link 165, from front end 202 to rear end 204. Top surface 250 may include a front end section 228, a widened central section 236, and a rear end section 230 that together form a continuous inclined surface that extends from an edge where tapered front end section 228 meets front end 202 to an edge where rear tapered end section 230 meets rear end 204. As shown in FIG. 2, front tapered end section 228 may be laterally offset from rear tapered end section 230, with widened central section 236 overlapping both front tapered end section 228 and rear tapered end section 230, widened central section 236 being wider than front tapered end section 228 and wider than rear tapered end section 230 as measured in an inward to outward direction of tapered track link 165.

FIG. 3 is a schematic view of a track link assembly 155 for contacting top carrier roller 110A and bottom track rollers 110B. An example of rollers 110A, 110B is shown opposite tapered top surface 250 of tapered track links 165 in FIG. 3.

As described above, each track link assembly 155 may include a pair of laterally-connected tapered track links 165. The example assembly 155 shown in FIG. 3 includes a first tapered track link 165A and a second tapered track link 165B connected to each other, a bushing 232 extending between track links 165A and 165B. A pin or other fastener (not shown in FIG. 3) may extend in bushing 232 for connecting third and fourth track links that are in front of, or behind, track links 165A and 165B. First tapered track link 165A and second tapered track link 165B may each have the same structure as tapered track link 165, described above, but with track links 165A and 165B being mirrored (e.g., first tapered track link 165A may form a left track link while second tapered track link 165B forms a right track link). A plane of symmetry of track links 165A and 165B may extend in a radial direction (e.g., toward a center or welding seam 350 of roller 110A, 110B) through a center of bushing 232.

First tapered track link 165A may have a first tapered top surface 250A that causes a height of first tapered track link 165A to be reduced in an outward direction from interior end 226A to outside end 224A. Second tapered track link 165B may have a second tapered top surface 250B that causes a height of second tapered track link 165B to be reduced in an outward direction from interior end 226B to outside end 224B.

As shown in FIG. 3, a first height H1 may be measured from a tallest point of tapered top surface 250 (e.g., at front tapered end section 228 or widened central section 236 shown in FIG. 2) to bottom end 206. A second height H2 may be measured from a shortest point of tapered top surface 250 (e.g., at widened central section 236 or at rear tapered end section 230) to bottom end 206. First height H1 may correspond to the maximum height of tapered track link 165 at front tapered end section 228 or widened central section 236, as measured from bottom end 206. H1 may correspond to the height of tapered track link 165 at the edge between interior end 226, or widened central section 236, and outside end 224.

If desired, first height H1 of first tapered track link 165A (not shown in FIG. 3) may be equal to first height H1 of second tapered track link 165B. In other aspects, first height H1 of first tapered track link 165A may be different from first height H1 of second tapered track link 165B.

In some aspects, second height H2 of first tapered track link 165A (not separately labelled in FIG. 3) may be equal to second height H2 of second tapered track link 165B. In other aspects, second height H2 of first tapered track link 165A may be different from first height H2 of second tapered track link 165B. In examples where first height H1 is equal for first tapered track link 165A (not separately labelled in FIG. 3) and second tapered track link 165B, second height H2 may be different between first tapered track link 165A and second tapered track link 165B. In other examples, second height H2 may be equal for first and second track links 165A, 165B, while first height H1 is different for track links 165A, 165B.

Carrier roller 110A and track rollers 110B may have shapes that are complementary to first tapered top surface 250A and second tapered top surface 250B. For example, rollers 110A, 110B may each include a first end 390 and a second end 395 that is disposed opposite first end 390. A roller shaft 385 may allow rollers 110A, 110B to rotate, facilitating motion of tapered track links 165 and other components of track link assembly 155.

A first inclined roller surface 308 of roller 110A, 110B may be configured to face and contact first tapered top surface 250A, the gap between first inclined roller surface 308 and first tapered top surface 250A being exaggerated in FIG. 3 as no gap may be present. Second inclined roller surface 310 of roller 110A, 110B may be configured to face and contact second tapered top surface 250B, with the gap between these structures also being exaggerated in FIG. 3. A roller shaft 385 may facilitate rotation of roller 110A, 110B during movement of machine 100.

First inclined roller surface 308 and first tapered top surface 250A may have the same angle of inclination. Example angles of inclination may be, for example, about 0.5° to about 6°, or about 2° to about 4°, measured as described below. In other aspects, the inclination of first inclined roller surface 308 may be greater than or less than the inclination of first tapered top surface 250A. Second inclined roller surface 310 and second tapered top surface 250B may have the same angle of inclination (e.g., about 0.5° to about 6°, or about 2° to about 4°). Alternatively, the inclination of second inclined roller surface 310 may be greater than or less than the inclination of second tapered top surface 250B.

In some aspects, rollers 110A, 110B may include flanges 315, 320 on first end 390 and second end 395, respectively. Flanges 315, 320 may be omitted (as represented by the dashed-lining at flanges 315, 320 in FIG. 3) as tapered top surface 250 may perform self-aligning functions for track assembly 105 without inclusion of physical stops, such as flanges 315, 320, on rollers 110A, 110B. Accordingly, at least some embodiments of rollers 110 (e.g., rollers 110A and rollers 110B) are entirely free of flanges.

FIG. 4 is a cross-sectional view of a portion of track assembly 105. The view of FIG. 4 illustrates four links 165, first tapered track link 165A, second tapered track link 165B, a third tapered track link 165C, and a fourth tapered track link 165D. The view of FIG. 4 shows rear tapered end section 230 of 165A and second tapered track link 165B, and front tapered end section 228 of third tapered track link 165C and fourth tapered track link 165D. As shown in FIG. 4, section 228 of each link 165 may be positioned adjacent with section 230 of another link 165, sections 228 and 230 of the adjacent links 165 forming a continuous taper extending across the two links 165.

Third tapered track link 165C may be connected by overlapping bushing bore 212 of third tapered track link 165C with pin bore 218 of first tapered track link 165A. Bushing 232 and link pin 234 may extend through overlapping bores 212 and 218 of these two track links 165A, 165C. Track links 165B and 165D may be connected in a corresponding manner.

Tapered top surfaces 250 may form an angle 252 (across first tapered track link 165A and third tapered track link 165C) or an angle 254 (across second tapered track link 165B and fourth tapered track link 165D) of about 0.5° to about 6°, or about 2° to about 4°. Angle 252 may be measured with respect to a horizontal direction. This horizontal direction may be parallel to an axis X-X that is defined by bushing 232 or by link pin 234.

### INDUSTRIAL APPLICABILITY

The tapered track link 165 and track link assembly 155 of the present disclosure can be used in track type machines 100, such as track type tractors, dozers, excavators, and skid-steer loaders. Specifically, tapered track link 165 and track link assembly 155, in accordance with the present disclosure, can be used to form two track assemblies 105 connected to respective tracks 160 for propulsion of machine 100.

During operation of machine 100, engine 120 may generate power for propulsion. Track assembly 105, formed of a series of serially-connected track link assemblies 155, may be driven by sprocket 140, via engine 120, to propel machine 100 in a forward direction, in a reverse direction, and to turn to the left or to the right. Each track 160 may travel along rollers 110A and rollers 110B, with tapered surfaces of track links 165 contacting and moving along tapered surfaces of rollers 110A and 110B, as well as tapered surfaces of sprocket 140 and front idler 145.

The disclosed tapered track link 165, track link assembly 155, and track assembly 105 may facilitate self-aligning functions of track assembly 105 during movement of machine 100. In some aspects, the tapered surface of each track link 165 may prevent track slippage, including slippage when machine 100 is traveling laterally along a sloped surface. The self-aligning configuration of track links 165 may facilitate the removal of flanges on track rollers, carrier rollers, or all rollers of track assembly 105. This may reduce manufacturing cost and allow for use of a single roller design such that all rollers (track rollers and carrier rollers) are identical to each other, reducing costs and facilitating precision forging or other manufacturing techniques for the rollers or other components of track assembly 105.

It will be apparent to those skilled in the art that various modifications and variations can be made to the disclosed tapered track link and track link assembly, and method of manufacture, without departing from the scope of the disclosure. Other embodiments of the tapered track roller, track roller assembly, and method of manufacture will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

What is claimed is:

1. A track link for a track link assembly, the track link comprising:
a first end;
a second end opposite to the first end;
an interior end extending between the first end and the second end;
an exterior end extending between the first end and the second end, the exterior end being opposite to the interior end; and
a top end having a tapered surface, the top end connecting the interior end and the exterior end, the interior end having a greater height as compared to a height of the exterior end due to the tapered surface.

2. The track link of claim 1, wherein the tapered surface is a flat surface with a constant angle of inclination.

3. The track link of claim 1, wherein the tapered surface forms an angle of inclination with a horizontal axis extending through the interior end and the exterior end, the angle of inclination being from about 0.5° to about 6°.

4. The track link of claim 1, wherein the tapered surface forms an angle of inclination with a horizontal axis extending through the interior end and the exterior end, the angle of inclination being from about 2° to about 4°.

5. The track link of claim 1, wherein the tapered surface includes a front tapered end at the first end of the track link and a rear tapered end at the second end of the track link, the front tapered end having a smaller height as compared to a height of the rear tapered end.

6. The track link of claim 5, wherein an angle of inclination of the front tapered end is the same as an angle of inclination of the rear tapered end.

7. The track link of claim 1, further including a fastener hole, the fastener hole extending through a bottom end that is opposite to the top end, the bottom end being configured to be attached to a track shoe via a fastener inserted through the fastener hole.

8. A track link assembly, comprising:
a first track link, the first track link having:
a first end;
a second end opposite to the first end;
an interior end extending between the first end and the second end;
an exterior end extending between the first end and the second end, the exterior end being opposite to the interior end; and
a top end having a tapered surface, the top end connecting the interior end and the exterior end; and
a second track link connected to and facing the first track link, the first track link having:
a first end;
a second end opposite to the first end;
an interior end extending between the first end and the second end;
an exterior end extending between the first end and the second end, the exterior end being opposite to the interior end; and
a top end having a tapered surface,
the top end of the first track link having a height that reduces in a direction from the interior end of the first track link to the exterior end of the first track link, and
the top end of the second track link having a height that reduces in a direction from the interior end of the second track link to the exterior end of the second track link.

9. The track link assembly of claim 8, wherein the top end of the first track link has a flat inclined surface that causes the height of the top end of the first track link to reduce.

10. The track link assembly of claim 8, wherein the top end of the first track link has a first flat inclined surface that causes the height of the top end of the first track link to reduce, and
the top end of the second track link has a second flat inclined surface that causes the height of the top end of the second track link to reduce.

11. The track link assembly of claim 10, wherein the first flat inclined surface forms a first angle with a horizontal direction and the second flat inclined surface forms a second angle with the horizontal direction, the first angle being substantially equal to the second angle.

12. The track link assembly of claim 11, wherein the first angle and the second angle are about 2° to about 4°.

13. The track link assembly of claim 10, wherein the first flat inclined surface forms a first angle with a horizontal direction and the second flat inclined surface forms a second angle with the horizontal direction, the first angle being different than the second angle.

14. The track link assembly of claim 8, wherein the first end of the first track link is a front end of the first track link and the second end of the first track link is a rear end of the second track link, the tapered surface being flat and extending from the front end of the first track link to the second end of the first track link.

15. A track assembly for a machine, the track assembly comprising:
a track shoe;
a first track link having:
a through hole;
a bottom surface connected to the track shoe;
a top surface opposite to the bottom surface, the top surface being inclined with respect to a horizontal direction;
a second track link; and
a track pin connecting the first track link and the second track link, the track pin extending through the through hole and along a track pin axis that is parallel to the horizontal direction.

16. The track assembly of claim 15, further including a third track link connected to the first track link, the third track link having a top surface, and
the top surface of the third track link being coplanar with the top surface of the first track link.

17. The track assembly of claim 15, wherein the second track link includes a top surface that opposes the top surface of the first track link, the top surface of the second track link being inclined in a direction that is transverse to a direction of inclination of the top surface of the first track link.

18. The track assembly of claim 17, further including a third track link connected to the first track link, the third track link having a top surface, and
the top surface of the third track link being coplanar with the top surface of the first track link.

19. The track assembly of claim 15, wherein the top surface of the first track link is a flat surface.

20. The track assembly of claim 19, wherein the top surface of the first track link tapers uniformly along an entirety of the flat surface formed by the top surface of the first track link.
